(19) United States
(12) Patent Application Publication
(10) Pub. No.: US 2025/0336601 A1
(43) Pub. Date: Oct. 30, 2025

(54) FABRICATION OF MnBi BONDED PERMANENT MAGNETS

(71) Applicant: Iowa State University Research Foundation, Inc., Ames, IA (US)

(72) Inventors: Wei Tang, Ames, IA (US); Jun Cui, Ames, IA (US)

(21) Appl. No.: 19/176,418

(22) Filed: Apr. 11, 2025

Related U.S. Application Data
(60) Provisional application No. 63/638,505, filed on Apr. 25, 2024.

(51) Int. Cl. H01F 41/02

(52) U.S. Cl. CPC H01F 41/0266

(57) ABSTRACT

The present invention provides a method for making anisotropic or isotropic MnBi bonded bulk permanent magnet wherein starting high purity α-MnBi (LTP) mono-crystalline fine feedstock powder particles or c-axis textured polycrystalline coarse powder particles are coated or covered with a single binder coating or a multi-binder coating system. The processed MnBi powder (which is coated or mixed with one or more polymer(s)) is pressed and/or consolidated to produce a dense anisotropic bonded magnet under a magnetic field or a dense isotropic bonded magnet without a magnetic field, at room temperature or elevated temperature. The polymer(s) used herein serve multiple functions: holding the powders together as a binder, isolating powder particles as a boundary phase to reduce magnetic exchange coupling among the particles and thus preferably retain a higher coercivity H_{c} close to that of the starting MnBi powder, and protecting the powder from oxidation.

### STATEMENT REGARDING RIGHTS TO INVENTION MADE UNDER FEDERALLY-SPONSORED RESEARCH AND DEVELOPMENT

This invention was made with Government support under Contract DE-AC02-07CH11358 awarded by the U.S. Department of Energy. The Government has certain rights in the invention.

### FIELD OF THE INVENTION

The present invention relates generally to the processes for manufacturing of non-rare earth permanent magnets. More particularly, the present invention relates to processes for large-scale production of bonded MnBi-based permanent magnets with high performance for energy conversion applications.

### BACKGROUND OF THE INVENTION

Manganese Bismuth (MnBi) is an attractive alternative to permanent magnets containing rare earth elements such as NdFeB-Dy and SmCo used in medium-temperature (423 K to 473 K) applications. Low temperature MnBi phase or LTP MnBi phase (also referred hereby as α-MnBi) has unique temperature properties, i.e. a positive temperature dependence of coercivity. For example, α-MnBi phase has a coercivity (H_{c}) value that increases with increasing temperature, reaching a maximum of 26 kOe at 523 K (250° C.). This large coercivity is attributed to MnBi's large magnetocrystalline anisotropy (1.6×10⁶ J/m³) and its dependence on the temperature sensitive lattice c/a ratio. α-MnBi has a moderest magnetization value. At room temperature, its saturation magnetization Mₛ is about 75 emu/g or 8.4 KG in a 5 T field. The corresponding maximum theoretical energy product (BH)ₘₐₓ is about 17.6 MGOe. The fabrication of MnBi-based magnets starts with preparing a high purity α-MnBi compound in a large quantity. However, synthesizing high purity α-MnBi is a challenging task. Melting temperatures of Mn and Bi are 1519 K (1246° C.) and 544 K (271° C.), respectively. The Mn-Bi phase diagram (ASM Alloy Phase Diagram Database, ASM International, Materials Park, OH, USA) shows that peritectic reactions occur over a wide range of temperatures and compositions, which encourages the formation of the undesired Mn phase. Processes are further complicated by a eutectic reaction that occurs between liquid bismuth (Bi) metal and solid MnBi at a temperature of 535 K (262° C.), which limits the maximum temperature to which feedstock materials can be exposed. While this eutectic temperature is about 112 K higher than the desired operating temperature of 423 K (150° C.), it is low for the conventional magnet fabrication methods that involve sintering and hot pressing for bulk anisotropic magnets.

Several parameters are used to characterize a magnetic material: remanent magnetization (Bᵣ), coercivity force (H_{c}), and maximum energy product (BH)ₘₐₓ). The (Bᵣ) value is a measure of magnet strength in the absence of an external magnetic field. The coercivity force or value (H_{c}) is a measure of a magnetic material's ability to remain magnetized in an external field. (BH)ₘₐₓ represents the maximum energy product between an induced magnetization value and a corresponding applied field. However, a high (Bᵣ) value or a high (H_{c}) value does not mean a high (BH)ₘₐₓ value, as many magnetic materials retain either a high (Bᵣ) value or a high (H_{c}) value, but not both. Moreover, even a material with high Bᵣ and H_{c}, the (BH)ₘₐₓ may still be poor due to the poor M-H curve squareness as the result of poor texture.

Major conventional approaches used to prepare materials with high purity α-MnBi phase include arc-melting, melt-spinning/rapid solidification and annealing. In the melt spinning approach, rapid cooling freezes MnBi in an amorphous phase. Subsequent heat treatment allows the amorphous phase to crystalize yielding the α-MnBi, at a purity over 90% by volume. However, production of large quantities of high purity α-MnBi monocrystalline powder with the desired grain size has not been reported, because the initial compositions and subsequent heat treatment temperatures were not well selected or controlled. In addition to the purity of the α-MnBi in the obtained powder, the size of the grain in each powder's particle is an important parameter to track. The right grain size (3-10 micron) is critical for achieving high degree of texture in the bulk magnet. If the grain size is too big, it is likely there is other phases forming during the grain growth due to the excessive exposure to high temperature; if the grain size is too small, after ball milling or jet milling to break the particle apart to single crystal, the obtained particle will be too small and easily oxidized.

US Publication 2021/0304933 describes a synthesis process for fabrication of mass quantities of high purity α-MnBi monocrystalline powder and subsequent fully dense anisotropic MnBi bulk magnets. That publication discloses innovative synthesis routes, including rapid solidification to obtain the alloy ingot or ribbons with high temperature MnBi phase (HTP MnBi), and transformation of HTP MnBi to LTP MnBi by using specific heat treatment profiles, comminution of alloys ingot or ribbons to obtain fine monocrystalline powder, and coating non-magnetic materials on the surface of powder using an in-situ or ex-situ method to obtain the feedstock powders for fabricating bulk magnet. That invention enables large scale production of monocrystalline fine feedstock powder (<10 μm, Mₛ up to 74 emu/g and H_{c} up to 13 kOe) with α-MnBi phase content exceeding 95% while maintaining a high yield close to 100%. The produced powder has to exhibit two characteristics in order to be used for making anisotropic bulk magnet: one is each powder particle has to be monocrystalline so that they can be aligned by magnetic field before or during the consolidation process to create anisotropy, the other is each powder particle has to be small, less than <10 μm in order to exhibit high H_{c}.

For purposes of illustration, a process for fabricating a quantity of a high-purity α-MnBi feedstock powder disclosed in the US Pub 2021/0304933, comprises:
melting a selected ratio of manganese (Mn) metal and bismuth (Bi) metal to provide a melted alloy represented by MnₓBi₁₀₀₋ₓ, x=48.5-53.5 at. % and then conducting at least one of a) rapidly solidifying the melted alloy by casting in a cooled metallic ingot mold that avoids amorphous phase formation upon cooling to form an as-cast ingot that includes a crystallized MnBi phase and b) melt-spinning the melted alloy at a wheel speed that avoids amorphous phase formation upon cooling to form as-melt-spun ribbon material that includes a crystallized MnBi phase,
annealing, in a single annealing step, the as-cast ingot or as-melt-spun ribbon material at about 270-350° C. for a time to form LTP MnBi (α-MnBi) phase therein to at least a purity of 90 volume %,
comminuting the ingot or ribbon material after the single annealing step to obtain comminuted monocrystalline powder particles with particles size less than 10 μm for bulk magnet manufacture by powder consolidation; and
providing a non-magnetic second phase in and/or on the comminuted powder particles by at least one of (a) forming a Bi-enriched phase interiorly of the powder particles and (b) coating a non-magnetic material on exterior surfaces of the powder particles wherein the second phase magnetically isolates MnBi grains at grain boundaries after bulk magnet manufacture by powder consolidation.

Thus, in practice of the invention of US Pub 2021/0304933, the feedstock powder is magnetically aligned, pressed, consolidated and warm-sintered without binder to obtain anisotropic sintered bulk magnets. The binder-free bulk magnets are incorporated as components of an electric machine or device.

### SUMMARY OF THE INVENTION

Certain embodiments of the present invention provide a method for making anisotropic or isotropic MnBi bonded permanent magnets wherein starting high purity α-MnBi feedstock monocrystalline fine powder particles and/or textured polycrystalline coarse powder particles are coated or covered by single binder or a multi-binder system. The multi-binder system includes a first inner polymer binder layer or coating deposited on the exterior surfaces of the powder particles to provide inter-grain boundary phase and thereby retain magnet coercivity (H_{c}) and a second outer different polymer binder layer or coating having higher mechanical strength (than the first inner polymer binder layer) to hold the particles together and also assist in improving magnet coercivity (H_{c}) of the bonded bulk magnet. The polymer(s) used in practice of the embodiments herein not only mechanically hold the powders together as a binder, but also function as a boundary phase to isolate powder particles from one another to reduce exchange coupling among the particles and thus retain a higher H_{c} of the bonded bulk magnet. In addition, the binders are well coated on the surfaces of highly oxygen sensitive fine powder to protect the powder and the bonded magnets from oxidization. The anti-oxidation coating on the bonded magnets may or may not be needed, depending on how well the powders are coated with the first layer, the coating materials selected, and how big the MnBi particles are. Such bonded magnets can have an H_{c} close to that of the starting MnBi powder and can stably function for a long-term in air. Certain exemplary embodiments of the present invention demonstrate that bonded MnBi bulk magnets pursuant to embodiments of the invention exhibit a higher He and mechanical strength than sintered MnBi ones, although remanence Bᵣ and maximum energy product (BH)ₘₐₓ of the bonded magnets are decreased to less than 70% of the theoretical magnetization due to the addition of more non-magnetic materials, i.e. polymers herein.

However, not all electric machines require magnet with high remanence magnetization. For example, “PM-assisted synchronous reluctance motor” requires magnet with high coercivity and moderate remanence. This is exactly what the bonded MnBi magnets can offer. This type of motor addresses the shortcoming of MnBi's magnet, which is low in remanence (Br), and takes full advantage of MnBi's strength, which is high in H_{c}.

### BRIEF DESCRIPTION OF THE DRAWINGS

FIG. 1 is a flow chart of overall MnBi bonded bulk magnet fabrication.

FIG. 2 illustrates steps 1a, 1b, 2, and 3 of FIG. 1 of preparation of MnBi feedstock powder for bonded bulk magnet fabrication.

FIG. 3 schematically illustrates steps 4a and 4b of FIG. 1of making isotropic and anisotropic bonded MnBi magnet.

FIG. 4 illustrates steps of FIG. 1 of machining and surface protection of bonded MnBi magnets.

FIG. 5 shows demagnetization curves of anisotropic bonded MnBi magnets with different additions of Bakelite.

FIG. 6 shows demagnetization curves of anisotropic and isotropic bonded MnBi magnets with 5 wt % QPAC based on magnet weight.

FIG. 7 shows demagnetization curve of anisotropic bonded MnBi magnet made from ground sintered MnBi magnet powder.

FIG. 8 shows demagnetization curve of anisotropic bonded MnBi magnet with 5 wt % acrylic resin.

FIG. 9 shows demagnetization curves of anisotropic bonded MnBi magnets with 25 wt % silicone resin based on magnet weight.

### DETAILED DESCRIPTION OF THE INVENTION

Certain embodiments of the present invention are useful to make anisotropic and isotropic bonded bulk MnBi magnets. In certain illustrative embodiments, MnBi powder having high purity of α-LTP (greater than or equal to 75 to 95% by volume), magnetization Mₛ of at least 50 emu/g, and coercivity H_{c} of at least 5 kOe is employed as the starting MnBi powder. Such starting high purity α-MnBi powder can be produced with a preferred particle size range of 3 to about 50 microns using the process described above for US Pub 2021/0304933, which is incorporated herein by reference. Or, the starting high purity α-MnBi powder can be obtained using the processes or methods below:
melting a selected ratio of manganese (Mn) metal and bismuth (Bi) metal by arc-melting or induction melting to provide an alloy represented by (MnₓBi₁₀₀₋ₓ, x=45-55 at. %) and then conducting at least one of (a) rapidly solidifying the melted alloy by casting the melt in a cooled metallic mold to form an as-cast ingot including a crystallized MnBi phase therein and (b) melt spinning the melted alloy at a wheel speed (1-8 m/s) to form strip cast flakes, solidified strip cast flakes that include a crystallized MnBi phase with fine grain (3 to about 10 μm), and (c) melt spinning the melted alloy at a wheel speed (10-20 m/s) to form ribbon flakes, solidified ribbon flakes that include a crystallized MnBi phase with ultrafine grains (<3 μm) therein;
annealing the as-cast ingots or strip cast flakes or ribbon flakes to promote the formation of LTP MnBi phase (α-MnBi) therein to at least a purity of 90 volume %; wherein the average grain size of annealed ingot or strip cast flakes or ribbon flakes is in the range of 3-10 microns. The annealing temperature is controlled to be <340° C. At this temperature the grain growth is limited.
comminuting the ingot or the strip cast flakes after annealing to obtain comminuted powder particles with fine average particle sizes of 3 to 10 μm for use in the bonded magnets. The particle size of the comminuted powder is comparable with the grain size, i.e. each particle is a monocrystal, which is required for the magnetic alignment process during anisotropic bulk magnet fabrication by pressing and/or consolidation using warm pressing or compaction, bonding, sintering, extrusion, molding, injection molding, and/or additive manufacturing method. The comminuting method includes, but is not limited to, ball milling and jet milling. To use any MnBi feedstock powder available in commercial market or provided by researchers and vendors for making bonded or non-bonded anisotropic bulk magnet close to full density, the feedstock powders must meet the requirements of Mₛ>50 emu/g, H_{c}>5 kOe, the particle size is 3-10 microns and each particle is monocrystal. If the comminuted powder contains polycrystalline particles, the achievable anisotropy of the obtained magnet typically will be reduced and result in reduced remanence magnetization.

However, certain embodiments of the invention envision grinding or other comminution of warm-sintered anisotropic magnets whose fabrication is described in US Pub 2021/0304933. The particles of the ground or other comminuted warm-sintered magnets are in the relatively coarse average particle size range of 10-500 microns and are polycrystalline, resembling a mini magnet, with the c-axis of each grain aligned to the same direction (c-axis crystallographic texture). These textured mini magnet particles are referred to as a magnet granule polycrystalline coarse particles herein.

The high purity α-MnBi starting powder is subjected to a feedstock processing step wherein the starting high purity α-MnBi monocrystalline fine powder particles and/or the textured magnet granule polycrystalline coarse powder particles is/are coated or covered with the single binder or a multi-binder system described below. The multi-binder system includes a first inner polymer binder layer or coating deposited on the exterior surfaces of the particles to provide intergrain boundary phase and thereby retain magnet coercivity (H_{c}) and a second outer different polymer binder layer or coating having higher mechanical strength to hold the particles together and also assist in improving magnet coercivity (H_{c}). The polymer binders can include, but are not limited to, Bakelite (phenol-formaldehyde polymer), epoxy, PPS (Polyphenylene Sulfide), Nylon PA12, Nylon PA6, Epoxy, Acrylic resin, Silicone resin, ABS (Acrylonitrile butadiene styrene), Polystyrene, Parylene, or any other polymers that are anhydrous, non-absorbing to oxygen, able to wet MnBi particle surfaces, and have a curing or hardening temperature typically in the range from room temperature to 150 to 250° C. Bakelite polymer, Epoxy, and Silicone are thermosetting polymers, while Nylon, ABS, Acrylic, Polystyrene, Parylene are thermoplastic polymers. In practice of embodiments of the invention, hardening of thermoplastic polymer binders occurs as part of the die pressing process described below by “physical curing” wherein the thermoplastic polymer binder softens/melts upon heating followed by hardening (solidifying) upon cooling. Thermosetting polymer binders undergo chemical curing. Besides the polymer binders, some optional surfactants or coupling agents such as Oleic acid, linoleic acid, Silane, Isopropyl alcohol and others are added to the binders, thereby increasing binder spreading and wetting of the MnBi particles. Flexible binders can be used as described below.

For the single binder system, the thickness of the polymer coating or layer on each particle is typically in the range of 0.02 to 0.7 microns. For the multi-binder system, the inner polymer binder layer can have this same or different thickness range while the outer polymer binder can have a typical thickness range of 0.25 to 1.0 microns.

In a particular embodiment, the processed high purity α-MnBi feedstock (i.e. the fine monocrystalline MnBi particles and/or the magnet granule polycrystalline coarse particles described above) is filled into a non-magnetic die, and magnetically aligned under a magnetic field of up to 5 T, and subsequently pressed and/or consolidated in the die into a dense anisotropic bonded bulk magnet at room temperature or elevated temperatures. This magnetic alignment step is effective when each powder particle is monocrystalline and also when the particles are the magnet granule polycrystalline coarse particles (mini magnets) described above so that they will physically rotate to match its crystalline c-axis, which is also its magnetic easy axis, with the applied field. If not monocrystalline particles or the polycrystalline mini magnet particles, the particles will have more than one grain, each with its own magnetic easy axis pointing to different direction, causing the particles to partially align with the applied magnetic field. The anisotropic bonded magnets can be directly made into near net-shape magnets, or big blocks that then are machined into required dimensions. The anisotropic bulk magnets are incorporated as components of an electric machine or device.

In another particular embodiment, the processed MnBi feedstock powder (i.e. the fine monocrystalline MnBi particles and/or the magnet granule polycrystalline coarse particles) is/are filled into a metal die and pressed and/or consolidated in the die into a dense isotropic bonded magnet at room temperature or elevated temperatures. The bonded isotropic bulk magnets can be directly made into near net-shape magnets, or big blocks that then are machined into required dimension(s). The bulk magnets are incorporated as components of an electric machine or device.

In the still another method embodiment, a mixture of the processed MnBi feedstock powder, (i.e. the fine monocrystalline MnBi particles and./or the magnet granule polycrystalline coarse particles) and the binder as well as other additives mentioned herein is heated and extruded through an extruder die one or more times forming long strands which are cut into uniform pellets suitable for use in injection molding or additive manufacturing. The resulting composite pellets are then used to produce net-shape isotropic or anisotropic bonded bulk magnets through injection molding, additive manufacturing and other consolidation-to-shape techniques. These bulk magnets can be incorporated as components in electric machines or devices. Alternatively, the composite pellets can be directly integrated into motor components or devices through injection molding, additive manufacturing or other consolidation technique by for example using the magnet slot in the motor as a mold into which a viscous mixture of MnBi powder and binder can be directly injected followed by in-situ magnetic alignment of the MnBi powder (e.g. using the motor's magnetic circuit) and curing.

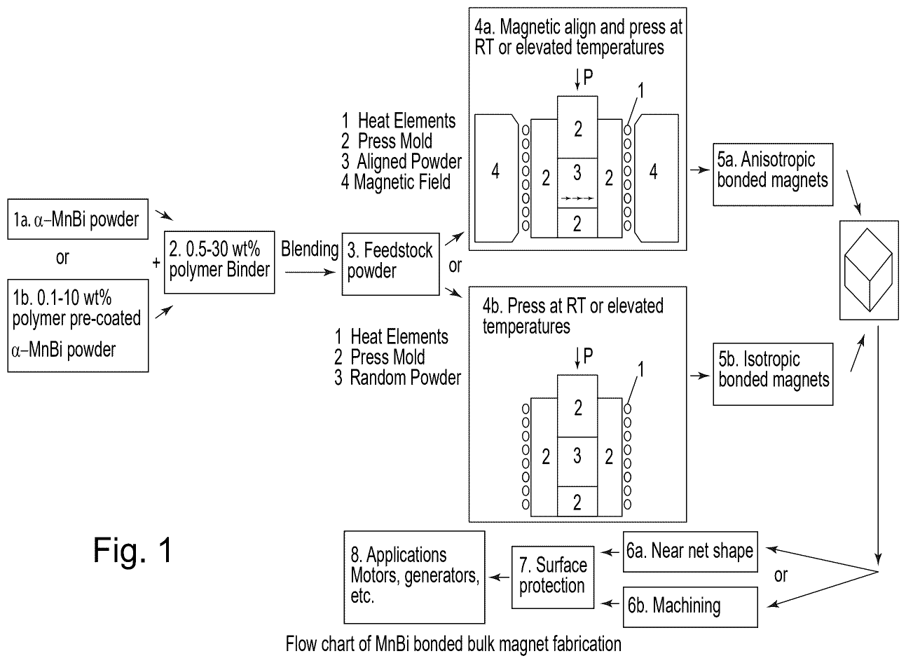

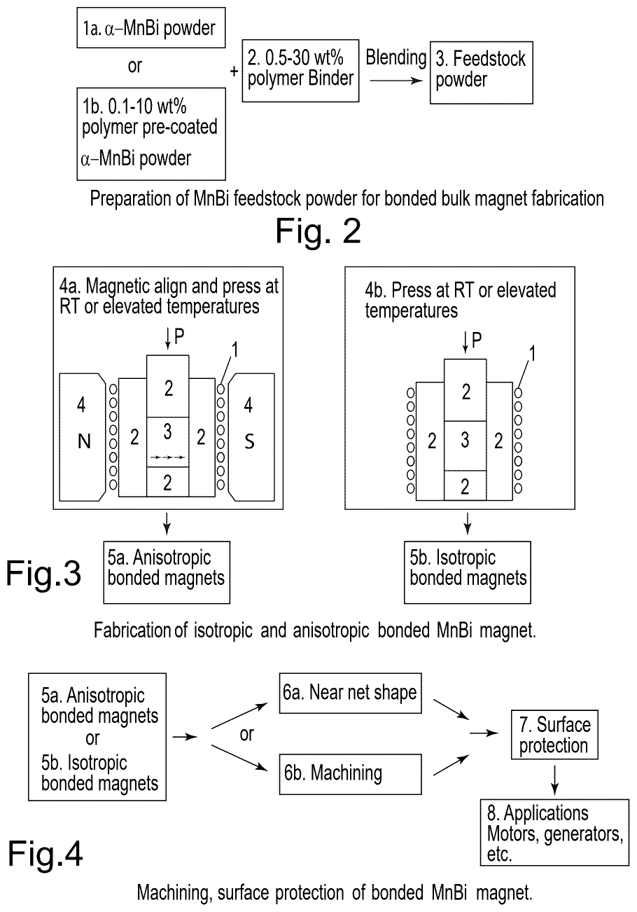

FIG. 1 illustrates the flow chart of fabricating bulk bonded magnets. The MnBi powder with high purity of α-MnBi phase and high magnetic performance (i.e. the fine monocrystalline MnBi particles and/or the magnet granule polycrystalline coarse particles) is used as the starting material (Step 1a or Step 1b where MnBi powder is polymer precoated). The MnBi powder of Steps 1a or 1b is coated or blended (mixed) with polymer binder in an inert atmosphere to form processed feedstock powder for bonded magnets (Steps 2 and 3) of FIGS. 1 and 2. The processed MnBi feedstock powder is filled into a die (press mold 2 in FIGS. 1 and 3), and then pressed under pressure P and/or consolidated with or without pressing into a fully or near fully dense anisotropic bonded bulk magnet under a magnetic field 4 (e.g. formed between magnets N, S of FIG. 3) to provide magnetically aligned powder 3 (as represented by the horizontal arrows) before/after pressing at room temperature or elevated temperatures (Steps 4a,5a), or is pressed and/or consolidated without a magnetic field into a full or near fully dense isotropic bonded bulk magnet (non-aligned random powder 3) at room temperature or elevated temperatures (Steps 4b,5b) where heating element(s) 1 provide(s) heating as needed. The processes of Steps 1-5 may be completed in air if the starting powder is coated with oxidization resistance materials or an inert atmosphere if the starting powder is without a sufficient oxidization resistive coating. The bonded bulk magnets can be directly made and shaped into near net-shape magnets (Step 6a), or big blocks that then are machined into required dimension(s) (Step 6b). The bulk magnets may be surface coated for oxidization protection (Step 7) before they are incorporated as components of an electric machine or device (Step 8).

The preparation of feedstock powder is shown in FIG. 2. The MnBi powder with high purity of α-MnBi phase herein is fabricated by the synthesis methods set forth In US Pub 2021/0304933, which is incorporated herein by reference, or any other synthesis method described above herein. The average powder particle size of the fine monocrystalline particles is in the range from 3 to 100, typically 3 to 10 microns. The average particle size of the magnet granule polycrystalline coarse particles is from 10 to 500 microns, typically 100-300 microns. Typical magnetic properties of the starting MnBi feedstock powder are Mₛ up to 75 emu/g (or up to 8.4 kGs), H_{c} up to 15 kOe at room temperature. In one embodiment, the starting high purity α-MnBi powder can be directly coated or mixed with at least one polymer binder of 0.1 to 30 wt % based on magnet weight in an inert atmosphere to obtain processed feedstock powder for making bonded bulk magnets as described steps 1a, 2 and 3 in FIG. 2.

In a certain other embodiment of the present invention, the starting high purity α-MnBi feedstock powder (i.e. the fine monocrystalline MnBi particles and/or the magnet granule polycrystalline coarse particles) is first coated by at least one thermosetting polymer of 0.1 to 10 wt % based on magnet weight, and then mixed/blended with at least another different thermoplastic polymer of 0.5 to 30 wt % based on magnet weight to obtain processed feedstock powder for bonded magnets as described Steps 1b, 2 and 3 in FIG. 2. The coating and blending polymers include, but are not limited to, Bakelite, epoxy, PPS (Polyphenylene Sulfide), Nylon PA12, Nylon PA6, Epoxy, Acrylic resin, Silicone, ABS (Acrylonitrile butadiene styrene), Polystyrene, or any other polymers described above. In an illustrative embodiment of the present invention, 2.5 wt % Bakelite powder is dissolved in acetone solvent to form a Bakelite solvent solution. The high purity α-MnB monocrystalline fine powder or polycrystalline coarse powder is soaked in the solution, then removed from the solution, and coated by the Bakelite after the acetone is vaporized in an inert atmosphere. The Bakelite-coated MnBi powder (average particle size less than 5 μm) is then blended with 5 wt % thermoplastic Nylon PA12 powder (average particle of about 30 microns wherein 5% by weight is based on weight of the processed feedstock powder. For example, In 10 g of processed feedstock powder, MnBi powder is 92.5 wt % or 9.25 g, Bakelite is 2.5 wt % or 0.25 g (gram), Nylon PA12 is 5 wt % or 0.5 g) to form the processed feedstock powder for bonded magnets.

The processed high purity α-MnBi feedstock powder (processed with single or multiple polymer binders) is filled into a non-magnetic metal die, magnetically aligned under a magnetic field of 0.5 T or above, then subsequently pressed and/or consolidated into a fully or near fully dense anisotropic bonded bulk magnet at room temperature or elevated temperatures as described in Step 4a, 5a in FIG. 3. In an illustrative embodiment of the present invention, the 2.5 wt % Bakelite-coated MnBi feedstock powder mixed with 5% Nylon PA12 powder is filled into a non-magnetic metal die. The die is heated to about 200° C., which is the melting point of Nylon PA12. The feedstock powder is then magnetically aligned under a magnetic field of 1.5 T, and then pressed in the die at a pressure of 3000 psi.

For producing an isotropic bulk magnet, the processed high purity α-MnBi feedstock powder is filled into a die, and then pressed and/or consolidated into a fully (98.5% of theoretical) or near fully (at least 96.5% of theoretical) dense isotropic bonded magnet at room temperature or elevated temperatures as described in Step 4b, 5b in FIG. 3. An isotropic bulk magnet is fabricated after cooling (if at elevated temperatures) and de-molding.

The MnBi monocrystalline fine feedstock powder coated with flexible multi-binder (Bakelite/Nylon PA12 system) can also be filled in a mold to consolidate the processed feedstock powder to a shape and is magnetically aligned under a magnetic field at room temperature or elevated temperature to fabricate a flexible anisotropic bonded bulk magnet, or without magnetic field at room temperature or elevated temperature to fabricate flexible isotropic bonded bulk magnet as described below.

As shown in FIG. 4, a MnBi bonded bulk magnet can be directly made into a near net shape magnet (Step 6a) for applications or made into a big block that are sliced (machined) into small pieces (Step 6b) for applications (Step 8). The bonded magnet can be in-situ assembled with electric machine components by injection molding or additive manufacturing followed by in-situ alignment of the MnBi powder using the motor's magnetic circuit and binder curing or hardening depending upon the binder used. The anti-oxidation surface coating for the protection of bonded magnets is optional, depending on the selection and amount of polymer binders in bonded magnets.

The following examples are offered to further illustrate, but not limit practice of the present invention:

### Example 1

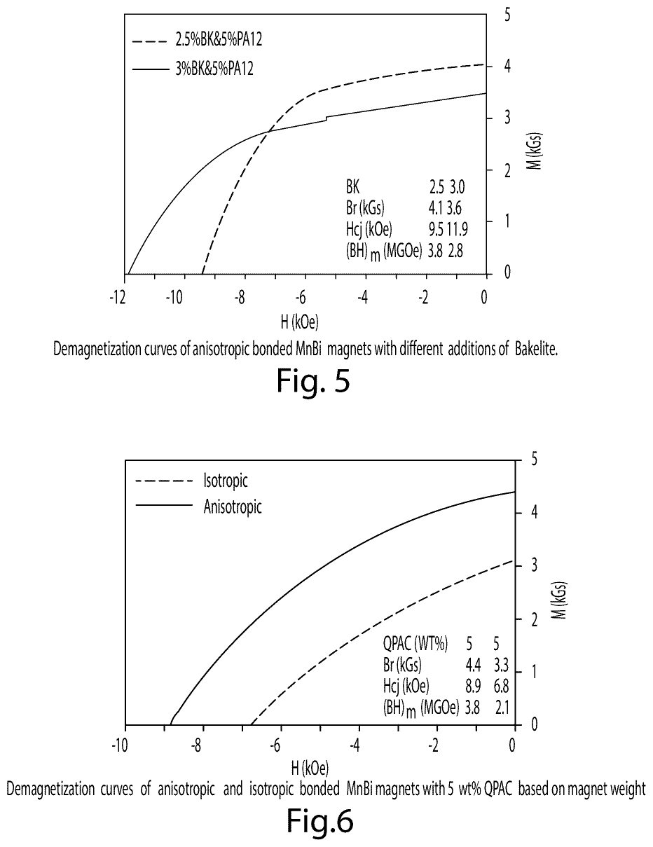

The following illustrative embodiments of the invention involve the effect of different addition amounts of different polymers on magnetic properties. The high purity-α-MnBi monocrystalline fine powder (as a starting powder) was obtained by the process described in US pub 2021/0304933; i.e., the powder having a starting composition of Mn_{0.51}Bi_{0.49} was melted and rapidly solidified by dropping cast into a cold mold to form casting ingots or melt spinning at a wheel speed of 2 m/s to form cast strip, followed by heat treatment at 290° C. for 2 to 6 days to provide the high purity α-MnBi and then comminuted to average particle size less than 5 microns with each particle being monocrystalline. The comminuted high purity α-MnBi powder was mixed with acetone solutions containing 2.5 and 3 wt % Bakelite (BK) binder, respectively. After the solution was vaporized, the Bakelite-coated MnBi powder was blended with 5 wt % Nylon PA12 powder (average particle size of 30 microns) to obtain processed feedstock powder. The processed feedstock powder was filled into a non-magnetic die and heated to 200° C., and then magnetically aligned under a magnetic field of 1.5 T and subsequently hydraulic pressed at a pressure of 3000 psi. All of these processes are completed in N₂ atmosphere. After cooling and de-molding, an anisotropic bonded cubie-shaped bulk magnet with dimensions of 6.75 mm is fabricated. The magnetic properties of the bonded bulk magnet were measured by a hysteresis-grapher and shown in FIG. 5. With Bakelite increasing from 2.5 to 3 wt %, coercivity H_{c} increased from 9.5 to 11.9 kOe, while Bᵣ and (BH)ₘₐₓ are decreased from 4.2 to 3.6 KG and 3.8 to 2.8 MGOe, respectively.

### Example 2

The following illustrative embodiments of the invention involve the fabrication of anisotropic and isotropic QPAC (QPAC-40) bonded MnBi magnets. The high purity α-MnBi monocrystalline fine powder as a starting material was obtained by the processes described in Example 1. This MnBi powder was mixed with acetone solution containing 5 wt % QPAC-40 polymer, which is poly (propylene carbonate. After the solution is vaporized, the QPAC-binder coated MnBi particles were filled into a non-magnetic die and pre-pressed without a magnetic field to form a compact, or alternatively magnetically aligned under a magnetic field of 1.5 T and then pre-pressed to form a compact. The pre-pressed compacts were cold-isostatic pressed (CIP) at a pressure of 500 MPa to enhance the density of the bulk magnets. All of these processes are completed in N₂ atmosphere. Demagnetization curves of bonded MnBi magnets with 5 wt % QPAC binder are shown in FIG. 6. The anisotropic bonded magnet obtained a higher Bᵣ, H_{c} and (BH)ₘₐₓ.

### Example 3

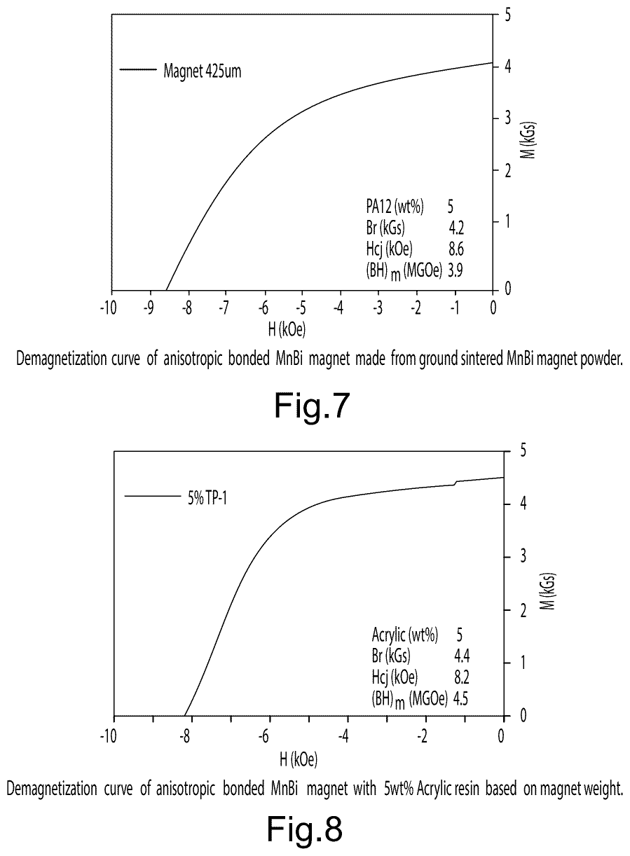

The following illustrative embodiments of the invention involve the fabrication of anisotropic bonded MnBi magnets made from ground sintered bulk magnet powder, i.e magnet granule polycrystalline coarse particles. A warm-sintered anisotropic MnBi bulk magnet is fabricated by using comminuted high purity α-MnBi powder described above in Example 1 and the sintering magnet fabricated process described in US pub 2021/0304933. The sintered anisotropic MnBi bulk magnet was ground by a mortar pestle or jaw crusher as 425-micron powder and then blended with 5 wt % Nylon PA12 powder to obtain processed feedstock powder. The processed feedstock powder was filled into a non-magnetic die and heated to 200° C., then magnetically aligned under a magnetic field of 1.5 T and subsequently hydraulic pressed at a pressure of 3000 psi. Although the ground powders are not monocrystalline, their anisotropy is as high as monocrystals because the warm-sintered magnet used monocrystalline powder as feedstock and has high degree of crystalline c-axis texture. All of these processes are completed in N₂ atmosphere. After cooling and de-molding, an anisotropic bonded cube-shaped magnet with dimensions of 6.75 mm was fabricated. The magnetic properties of the bonded bulk magnet were measured by hysteresis-grapher and shown in FIG. 7. The bonded magnet obtained a H_{c} of 8.6 kOe and (BH)ₘₐₓ of 3.9 MGOe.

### Example 4

The following illustrative embodiment of the invention involve the fabrication of anisotropic bonded MnBi magnets with acrylic resin binder. High purity α-MnBi monocrystalline fine powder as a starting material was obtained as described in Example 1. The MnBi powder was blended by acetone solutions containing 5 wt % Acrylic resin based on magnet weight to obtain processed feedstock powder. The processed feedstock powder was filled into a non-magnetic die and heated to 160° C., then magnetically aligned under a magnetic field of 1.5 T and subsequently hydraulic pressed at a pressure of 3000 psi. All of these processes are completed in N₂ atmosphere. After cooling and de-molding, an anisotropic bonded cubic magnet with dimensions of 6.75 mm was fabricated. The magnetic properties of the bonded magnet were measured by a hysteresis-grapher and shown in FIG. 8. The bonded magnet obtained a H_{c} of 8.2 kOe and (BH)ₘₐₓ of 4.5 MGOe.

### Example 5

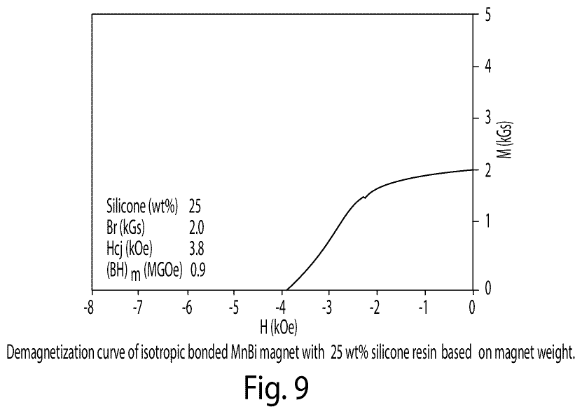

The following illustrative embodiment of the invention involves the fabrication of flexible bonded MnBi magnets. The high purity α-MnBi monocrystalline fine powder as a starting material was obtained by the process described in Example 1. The MnBi powder was mixed with 25 wt % silicone resin thermosetting binder to obtain highly flowable processed feedstock powder. The processed feedstock powder was filled (poured) into a mold to achieve powder consolidation to a shape without pressing and cured (curing of the thermosetting binder) at room temperature with or without a magnetic field. After curing of the thermosetting binder, an anisotropic or isotropic flexible bonded bulk magnet with shape dimensions of 25×25×5 mm was fabricated. The magnetic properties of an isotropic flexible bonded bulk magnet were measured by a hysteresis-grapher and shown in FIG. 9. The flexible magnet obtained a H_{c} of 3.8 kOe and (BH)ₘₐₓ of 0.9 MGOe.

Although the invention has been described above with respect to certain embodiments for purposes of illustration, those skilled in the art will appreciate that modifications can be made thereto without departing from the scope of the invention as set forth in the appended claims.

We claim:

1. A process for fabricating a bonded MnBi magnet, comprising:
providing high purity α-MnBi feedstock powder comprising monocrystalline fine powder and/or textured polycrystalline coarse powder as a starting powder material.
providing a coating or layer of at least one polymer binder on the feedstock powder to obtain processed feedstock powder,
subjecting the processed feedstock powder to at least one of pressing and/or consolidating into an anisotropic bonded magnet under a magnetic field at room temperature or elevated temperature, or into an isotropic bonded magnet without a magnetic field at room temperature or elevated temperature, and
curing or hardening the at least one polymer binder as part of fabrication of the anisotropic bonded magnet under a magnetic field, or of the isotropic bonded magnet without a magnetic field.

2. The process of claim 1, wherein the at least one polymer binder comprises at least one of Bakelite, epoxy, PPS (Polyphenylene Sulfide), Nylon PA12, Nylon PA6, epoxy, acrylic resin, silicone, ABS (Acrylonitrile butadiene styrene), polystyrene, parylene and/or other polymers and optionally a corresponding surfactant or agent for a selected polymer to improve spreading and wettability of the polymer.

3. The process of claim 1 including providing a first polymer binder layer or coating deposited on exterior surfaces of the particles to provide inter-grain boundary phase and thereby retain magnet coercivity (H_{c}) and a second outer different polymer binder layer or coating having higher mechanical strength to hold the particles together and assist in improving magnet coercivity (H_{c}).

4. The process of claim 1, wherein at least one polymer binder is coated on the surface of the MnBi powders by contact of the MnBi powders with a solvent solution of dissolved polymer binder followed by removal of the solvent.

5. The process of claim 1 wherein the polymer binder is a thermoplastic polymer which is hardened or a thermosetting polymer which is cured.

6. The process of claim 1 including providing the feedstock powder with a thermoplastic coating or layer and a thermosetting coating or layer.

7. The process of claim 1, wherein the processed feedstock powder is filled into a non-magnetic die, and magnetically aligned under a magnetic field and then pressed at room temperature or elevated temperatures to fabricate an anisotropic bonded MnBi magnet.

8. The process of claim 1, wherein the processed feedstock powder is filled into a die and then pressed at room temperature or elevated temperature to fabricate an isotropic bonded MnBi magnet.

9. The process of claim 1, wherein the processed feedstock powder is filled into a mold for consolidation to a shape and cured or hardened under a magnetic field at room temperature or elevated temperature above room temperature to fabricate an anisotropic bonded MnBi magnet.

10. The process of claim 1, wherein the processed feedstock powder is filled into a mold for consolidation to a shape and cured or hardened without a magnetic field at room temperature or elevated temperature above room temperature to fabricate an isotropic bonded MnBi magnet.

11. The process of claim 1, wherein the pressing and/or consolidating include(s) uniaxial pressing and/or isostatic pressure.

12. The process of claim 1, wherein the pressing and/or consolidating include(s) extrusion, warm compaction, molding to a shape, injection molding, and/or additive manufacturing.

13. The process of claim 1 wherein all of process steps are completed in air or inert atmosphere.

14. The process of claim 1, wherein the bonded magnet is directly made into near net-shape magnet or into a block that is then machined to required dimension.

15. The process of claim 1, wherein an outer surface of the bonded MnBi magnet is coated for anti-oxidization protection. Page 27

16. The process of claim 1, wherein the bonded MnBi magnet is incorporated as a component of an electric machine or device.

17. The process of claim 1 including forming the bonded MnBi magnet in-situ on a component of an electric machine or device.

18. The process of claim 17 wherein the bonded MnBi magnet is formed in-situ by injection molding or additive manufacturing.

19. A bonded MnBi magnet made by the method of claim 1.

20. A bonded MnBi magnet made by the method of claim 3.
